(19) United States
(12) Patent Application Publication
(10) Pub. No.: US 2008/0113544 A1
(43) Pub. Date: May 15, 2008

(54) ELECTRICAL CONNECTOR

(75) Inventor: Chien Chih HO, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Anloku (TW)

(21) Appl. No.: 11/872,259

(22) Filed: Oct. 15, 2007

(30) Foreign Application Priority Data
Nov. 15, 2006 (CN) 200620067685.2
Nov. 15, 2006 (CN) 200620067687.1
Nov. 15, 2006 (CN) 200620067688.6

(51) Int. Cl. H01R 4/50

(52) U.S. Cl. 439/342

(57) ABSTRACT

The invention relates to an electrical connector including an insulating body and a plurality of conductive terminals. The conductive terminal includes a fastening part and a contacting part connecting to an electrical component. The insulating body has a plurality of terminal holes along a direction which the contacting part of the conductive terminal extends along. Wherein, the contacting parts of the Nth row of the conductive terminal extends and passes through between the (N+1)th row. Accordingly, the electrical connector of the invention has a suitable distance between the conductive terminals, and a short circuit can be avoided. Further, an electrical connection between the conductive terminal and the electrical component is more stable, and the conductive terminals can be arranged compactly.

### BACKGROUND OF THE INVENTION

1. Field of the Invention

The present invention relates to an electrical connector and particularly to an electrical connector for connecting a land grid array chip module with a circuit board.

2. Description of the Prior Art

So far, an electrical connector is generally used for connecting a land grid array chip module with a circuit board. The electrical connector generally includes an insulating body and a plurality of conductive terminals.

According to U.S. Pat. No. 6,908,313, the patent discloses an electrical connector with a high-density arrangement and capable of compressively contacting an electrical component. The electrical connector includes a plurality of conductive terminals and an insulating body. The insulating body has a plurality of terminal holes. The conductive terminals can be accommodated in the terminal holes. Each of the conductive terminals includes a fastening part in coordination with the insulating body, a welding part extending downward from the fastening part, and a contacting part extending upward from the fastening part. Wherein, the welding part can be soldered on the circuit board, and the contacting part extends to a top of an adjacent conductive terminal, so as to compressively contact a metal pad of the electrical component.

However, a disadvantage of the electrical connector in the prior art is a compact arrangement of the conductive terminals. The contacting part is above an adjacent conductive terminal, so a short circuit easily occurs when the conductive terminal is connected to an electrical component. Further, the electrical connection between the electrical connector and the electrical component are not stable.

Therefore, the invention provides an electrical connector to solve the aforesaid disadvantage.

### SUMMARY OF THE INVENTION

A scope of the invention is to provide an electrical connector capable of providing a stable electrical connection between an electrical component and the electrical connector.

According to a preferred embodiment of the invention, the electrical connector includes an insulating body and a plurality of conductive terminals. The insulating body includes a plurality of terminal holes. Each of the conductive terminals includes a fastening part and a contacting part, and the fastening part is correspondingly disposed in one of the terminal holes.

Wherein, the terminal holes are arranged into multiple rows extending along a direction which the contacting part extends along. The contacting part of the conductive terminal disposed in one of the Nth row of the terminal holes extend and passes through between two adjacent terminal holes of the (N+1)th row of the terminal holes, and N is a natural number. A terminal hole area is formed along directions of two adjacent sides of one of the terminal holes.

Accordingly, compared with the prior art, the contacting part of the electrical connector of the invention extends to an area out of a terminal hole area of adjacent row of the conductive terminals. A suitable distance can be kept between the conductive terminals, and the conductive terminal has a longer contacting part to avoid a short circuit. Further, an electrical connection between an electrical component and the conductive terminal is more stable than the prior art, and the conductive terminals can be compactly arranged.

The advantage and spirit of the invention may be understood by the following recitations together with the appended drawings.

### BRIEF DESCRIPTION OF THE APPENDED DRAWINGS

FIG. 1 illustrates a top view of an electrical connector according to a first preferred embodiment of the invention.

FIG. 2 illustrates a cross-section view along B-B line of the electrical connector in FIG. 1.

FIG. 3 illustrates a top view of an electrical connector according to a second preferred embodiment of the invention.

FIG. 4 illustrates a cross-section view along D-D line of the electrical connector in FIG. 3.

FIG. 5 illustrates a cross-section view of an electrical connector according to an embodiment.

FIG. 6 illustrates a top view of an electrical connector according to a third preferred embodiment of the invention.

FIG. 7 illustrates a cross-section along E-E line of the electrical connector in FIG. 6.

FIG. 8 illustrates a cross-section along F-F line of the electrical connector in FIG. 6.

FIG. 9 illustrates a top view of an electrical connector according to a forth preferred embodiment of the invention.

FIG. 10 illustrates a cross-section along H-H line of the electrical connector in FIG. 9.

### DETAILED DESCRIPTION OF THE INVENTION

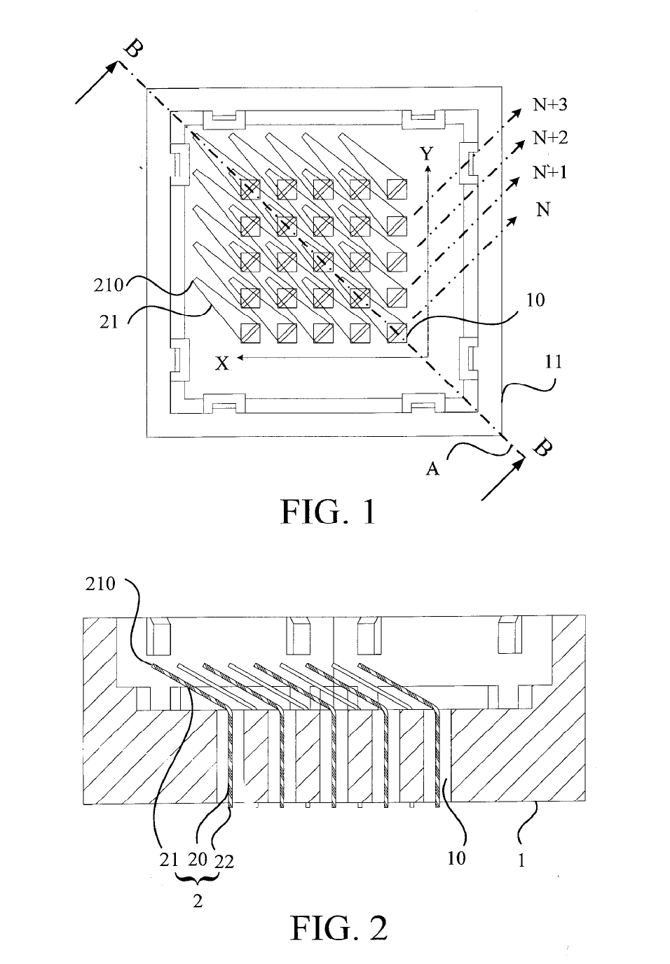

Please refer to FIG. 1 and FIG. 2. FIG. 1 illustrates a top view of an electrical connector according to a first preferred embodiment of the invention. FIG. 2 illustrates a cross-section view along B-B line of the electrical connector in FIG. 1. The electrical connector of the invention includes an insulating body 1 and a plurality of conductive terminals 2. The electrical connector is used for electrically connecting a circuit board (not shown) with an electrical component (not shown), such that the electrical connector is capable of connecting a land grid array chip module with a circuit board.

In the first embodiment, each of the conductive terminals 2 includes a fastening part 20 for fastening the conductive terminal 2 on the insulating body 1, a contacting part 21 extending upward from the fastening part 20, and a welding part 22 extending downward from the fastening part 20. The contacting parts 21 of all conductive terminals are symmetrically disposed relative to a center line A (alternatively, B-B line), and compressively contact the electrical component to establish an electrical connection. A solder (not shown) can be disposed on an end of the welding part 22 to make the conductive terminals 2 to be weld on the circuit board.

The insulating body 1 has a plurality of terminal holes 10 arranged along a direction which the contacting part 21 of the conductive terminal 2 extends along. The conductive terminal 2 is disposed in the terminal holes 10 of the insulating body 1. The terminal hole 10 is a square-shape hole, and the fastening part 20 is configured in a diagonal of the terminal hole 10. Further, the conductive terminal 2 is fastened in the insulating body 1.

As shown in FIG. 1, the contacting parts 21 of the Nth row of the conductive terminals 2 extend and pass through between the (N+1)th row, and extend to a top of the (N+2)th row. Of course, the contacting parts 21 of the Nth row of the conductive terminals 2 can further extend beyond a terminal hole area of the (N+2)th row. Because the contacting parts 21 of the Nth row of the conductive terminals 2 do not extend and pass through a top of the (N+1)th row, the contacting parts 21 of the conductive terminals 2 can extend longer. Such that, a suitable distance between the conductive terminals 2 can be kept, and a short circuit can be avoided when the conductive terminal 2 connects to an electrical component.

One of the Nth row of the terminal hole 10 is between two adjacent terminal holes 10 of the (N+1)th row of the terminal holes 10. The Nth row and the (N+1)th row of the terminal holes 10 are staggered. The center lines A corresponding to the contacting parts 21 of multiple rows of the conductive terminals 2 are collinear. An angle between the center line A and an edge 11 of the insulating body 1 is 45 degrees.

A terminal hole area is formed along directions (X and Y direction shown in FIG. 1) of two sides of one of the terminal holes 10. The contact point 210 of the conductive terminal 2 is above an area out of the terminal hole area. As shown in FIG. 1, the contact point 210 of one of the Nth row of the conductive terminal 2 is between two adjacent terminal holes 10 of the (N+3)th row of the terminal holes 10. Of course, the contact point 210 can be above or beyond a top of the (N+2)th row of the terminal holes 10.

Accordingly, the electrical connector of the invention has a suitable distance between the conductive terminals, and a short circuit between the conductive terminals can be avoided. Further, an electrical connection between the conductive terminal and an electrical component can be more stable.

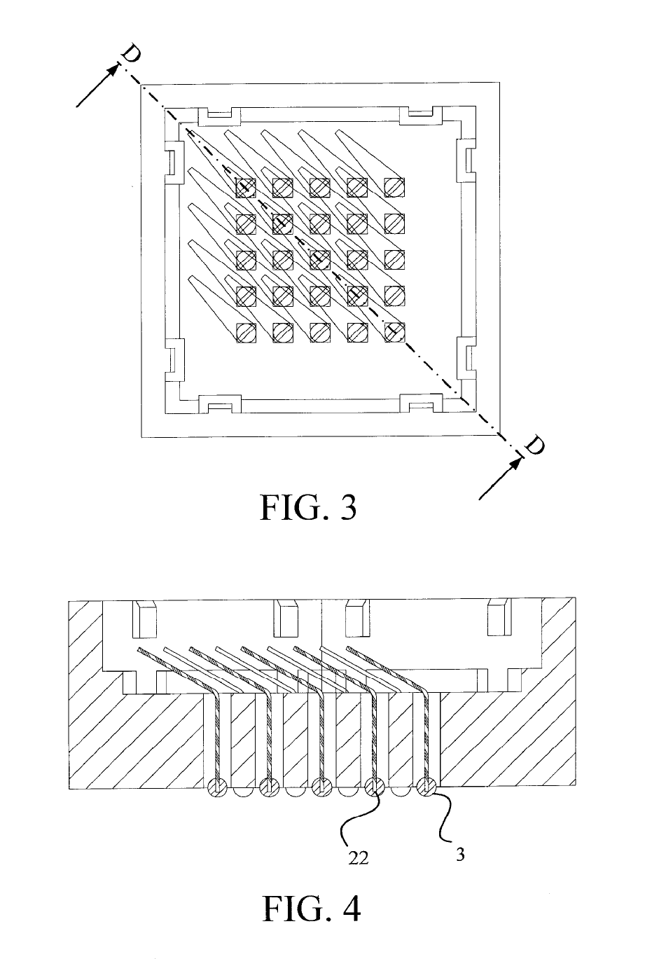

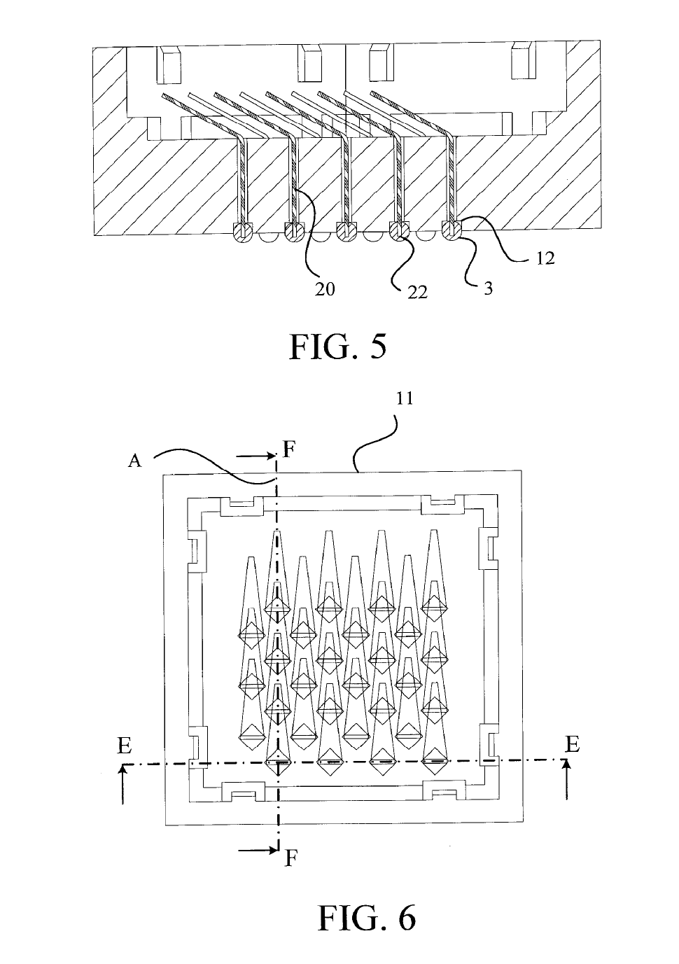

Please refer to FIG. 3 and FIG. 5. FIG. 3 illustrates a top view of an electrical connector according to a second preferred embodiment of the invention. FIG. 4 illustrates a cross-section view along D-D line of the electrical connector in FIG. 3. FIG. 5 illustrates a cross-section view of an electrical connector according to an embodiment. The difference between the second embodiment and the first embodiment is that there is a tin ball 3 disposed on an end of the welding part 22 (shown in FIG. 4). Further, the conductive terminal 2 can be soldered on a circuit board to achieve the same function illustrated in the aforesaid embodiment. Of course, as shown in FIG. 5, a shape of the terminal hole and a shape of the fastening part 20 are substantially the same, and a space 12 for accommodating the tiny ball 3 is configured below the terminal hole.

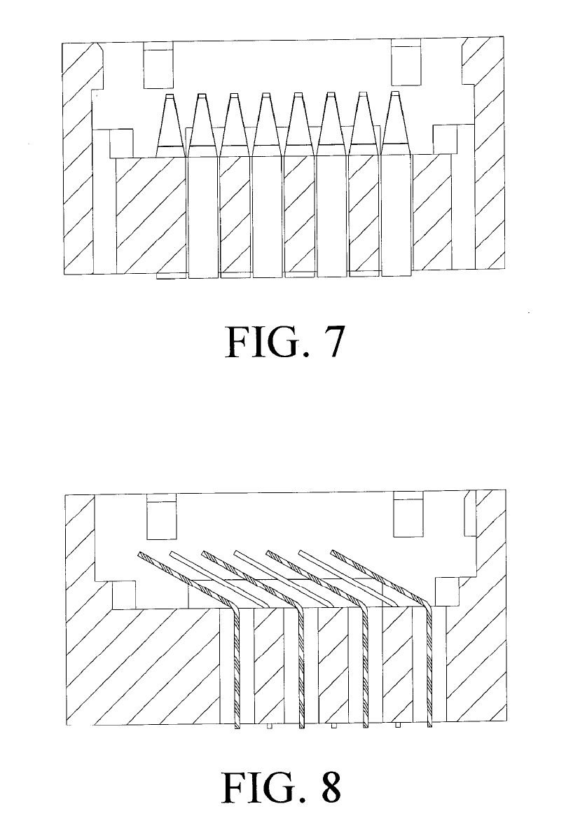

Please refer to FIG. 6 through FIG. 8. FIG. 6 illustrates a top view of an electrical connector according to a third preferred embodiment of the invention. FIG. 7 illustrates a cross-section along E-E line of the electrical connector in FIG. 6. FIG. 8 illustrates a cross-section along F-F line of the electrical connector in FIG. 6. The difference between the third embodiment and the first embodiment is that an angle between a center line A and an edge of the insulating body 11 is perpendicular. The third embodiment can achieve the same function illustrated in the aforesaid embodiments.

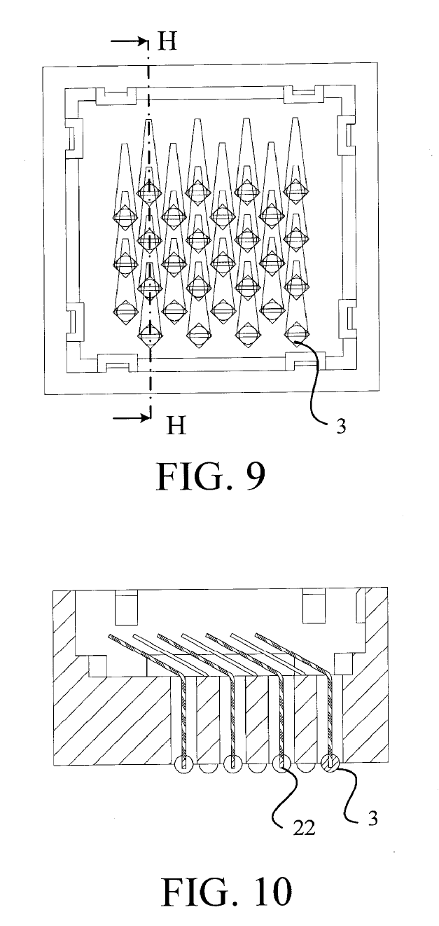

Please refer to FIG. 9 and FIG. 10. FIG. 9 illustrates a top view of an electrical connector according to a forth preferred embodiment of the invention. FIG. 10 illustrates a cross-section along H-H line of the electrical connector in FIG. 9. The difference between the forth embodiment and the third embodiment is that there is a tin ball 3 disposed on an end of the welding part 22 (shown in FIG. 10). Further, the conductive terminal 2 can be soldered on a circuit board to achieve the same function illustrated in the aforesaid embodiments.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector, comprising:
an insulating body comprising a plurality of terminal holes; and
a plurality of conductive terminals, each of the conductive terminals comprising a fastening part and a contacting part extending upward from the fastening part, the fastening part being correspondingly disposed in one of the terminal holes;
wherein the terminal holes are arranged into a plurality of rows along a direction which the contacting part extends along, the contacting part of the conductive terminal disposed in one of the Nth row of the terminal holes extends and passes through between two adjacent terminal holes of the (N+1)th row of the terminal holes, and N is a natural number.

2. The electrical connector of claim 1, wherein a terminal hole area is formed along directions of two adjacent sides of one of the terminal holes, and a contact point of the conductive terminal disposed in said terminal hole is above an area out of the terminal hole area.

3. The electrical connector of claim 1, wherein the contacting parts of each row of the conductive terminals are disposed symmetrically relative to a corresponding center line, the center lines corresponding to the contacting parts of each row of the conductive terminals are collinear.

4. The electrical connector of claim 3, wherein an angle between the center line and an edge of the insulating body is 45 degrees.

5. The electrical connector of claim 3, wherein the center line is perpendicular to an edge of the insulating body.

6. The electrical connector of claim 3, wherein one of the Nth row of the terminal holes is between two adjacent holes of the (N+1)th row of the terminal holes, and the Nth row of the terminal holes and the (N+1)th row of the terminal holes are staggered.

7. The electrical connector of claim 6, wherein a contact point of one of the Nth row of the conductive terminals is above the (N+2)th row of the terminal holes.

8. The electrical connector of claim 6, wherein a contact point of one of the Nth row of the conductive terminals is between two adjacent terminal holes of the (N+3)th row of the terminal holes.

9. The electrical connector of claim 6, wherein a contact point of one of the Nth row of the conductive terminals is beyond a top of the (N+2)th row of the terminal holes.

10. The electrical connector of claim 1, wherein the fastening part of the conductive terminal is disposed in a diagonal of the corresponding terminal hole.

11. The electrical connector of claim 1, wherein the contacting parts of the Nth row of the conductive terminals extend to a top of the (N+2) row of the terminal holes.

12. The electrical connector of claim 1, wherein the contacting parts of the Nth row of the conductive terminals extend beyond a top of the (N+2) row of the terminal holes.

13. The electrical connector of claim 1, wherein a shape of the terminal holes and a shape of the fastening part are substantially the same, and a space for accommodating a tin ball is configured below the terminal hole.

14. The electrical connector of claim 1, wherein the conductive terminal comprises a welding part extending downward from the fastening part, and a solder is disposed on an end of the welding part.
